(19) United States
(12) Patent Application Publication
(10) Pub. No.: US 2025/0115004 A1
(43) Pub. Date: Apr. 10, 2025

(54) METHOD FOR PLANNING THE LOCAL SOLIDIFICATION OF A LAYER OF POWDER MATERIAL WHEN MANUFACTURING A THREE-DIMENSIONAL OBJECT LAYER BY LAYER

(71) Applicant: TRUMPF Laser- und Systemtechnik GmbH, Ditzingen (DE)

(72) Inventors: Bernhard Gutmann, Pfaffenhofen a.d. Glonn (DE); Dominik Maurer, Stuttgart (DE)

(21) Appl. No.: 18/986,784

(22) Filed: Dec. 19, 2024

Related U.S. Application Data
(63) Continuation of application No. PCT/EP2023/064576, filed on May 31, 2023.

(30) Foreign Application Priority Data
Jun. 24, 2022 (DE) 10 2022 115 803.9

(51) Int. Cl. B29C 64/393; B29C 64/153; B29C 64/264; B33Y 10/00; B33Y 30/00; B33Y 50/02

(52) U.S. Cl. CPC B29C 64/393; B29C 64/153; B29C 64/264; B33Y 10/00; B33Y 30/00; B33Y 50/02

(57) ABSTRACT

A method for planning local solidification of a layer of powder material with a high-energy beam while manufacturing a three-dimensional object layer by layer includes determining a inskin area and a downskin area, defining an inskin pattern for the inskin area and downskin pattern for the the downskin area independently, by defining geometric progression of inskin vectors in the inskin area and defining geometric progression of downskin vectors in the downskin area, and defining a processing sequence of the inskin vectors and the downskin vectors, by defining inskin vector blocks and downskin vector blocks. Each inskin vector block includes inskin vectors to be processed successively. Each downskin vector block includes downskin vectors to be processed successively. The method further includes defining a vector-block sequence for processing the inskin vector blocks and the downskin vector blocks alternately.

### CROSS REFERENCE TO RELATED APPLICATIONS

This application is a continuation of International Application No. PCT/EP2023/064576 (WO 2023/247147 A1), filed on May 31, 2023, and claims benefit to German Patent Application No. DE 10 2022 115 803.9 filed on Jun. 24, 2022. The aforementioned applications are hereby incorporated by reference herein.

### FIELD

Embodiments of the present invention relate to a method for planning the local solidification of a layer of powder material with a high-energy beam when manufacturing a three-dimensional object layer by layer.

### BACKGROUND

A procedure is known from EP 3 563 203 B1.

Methods for the layer-by-layer manufacturing of three-dimensional objects, which are also known as 3D printing, enable the manufacturing of such objects with a great deal of design freedom and with comparatively little expenditure of time. The objects are manufactured layer-by-layer from a powder, wherein the layers are locally irradiated with a high-energy beam to solidify them. The movement of the high-energy beam on a layer to be processed during the manufacturing method is defined by vectors.

The layer to be processed is typically divided into parts, in which the vectors and/or the associated parameters of the high-energy beam are selected differently. It is important here to distinguish between inskin areas and downskin areas. In the context of the application, an inskin area is understood to mean, in particular, a section of the layer to be processed which is positioned on a part of an underlying powder layer which is solidified during the manufacturing of the object. In the context of the application, a downskin area is understood to mean, in particular, a section of the layer to be processed which is positioned on a part of an underlying powder layer which remains unsolidified during the manufacturing of the object. Downskin vectors are used to process a downskin area. Accordingly, to process an inskin area, inskin vectors are used, which can differ from the downskin vectors, for example with regard to their line energy or their length.

FIG. 4a of EP 3 563 203 B1 discloses a method for the layer-by-layer manufacturing of an object, wherein a layer of the object has a sandwich area and a downskin area adjacent to the sandwich area. A high-energy beam is initially guided along parallel hatch lines in one of these two areas in order to solidify the area in question. The high-energy beam is then guided in a corresponding manner along parallel hatch lines in the other of the two areas in order to solidify the other area as well. Thus, the solidification of one area is completed before the solidification of the other area begins. Such a method is comparatively easy to implement.

If, during such a layer-by-layer manufacturing of a three-dimensional object with a high-energy beam in an inskin area or especially in a downskin area, all consecutive vectors are exposed directly one after the other, there is a risk of local overheating, which leads to reduced buildability. Overheating can be avoided by waiting times. However, this increases the processing time and reduces the productivity of the manufacturing method.

In EP 3 563 203 B1, specifically FIG. 4b therein, a method is also disclosed in which a high-energy beam is guided along continuous hatch lines over the boundary lines between a downskin area and a sandwich area, wherein, when changing between the downskin area and the sandwich area, beam parameters of the high-energy beam are changed to adapt to the respective area. Such a method is intended to reduce thermal stresses at the boundary between the downskin area and the sandwich area.

However, by using continuous hatch lines, the characteristics of both the downskin area and the sandwich area must be taken into account simultaneously when selecting the vectors. The pattern of vectors results from a compromise between the properties of the two areas. This makes it difficult to select vectors that are optimized for the respective area, for example with regard to the density of the vectors. As a rule, the downskin area is therefore not processed optimally.

U.S. Pat. No. 9,676,032 B2 relates to a method for the layer-by-layer manufacturing of a three-dimensional object, wherein a first area of a powder layer with parallel scan lines is exposed in a first direction by a high-energy beam and a second area with parallel scan lines is exposed in a second direction. A scan line in the first area is exposed or melted immediately before a scan line in the second area. After applying another powder layer, the first area is exposed on parallel scan lines in a third direction and the second area is exposed on parallel scan lines in a fourth direction. This method is intended to reduce the time required to manufacture the object.

FIG. 12 of DE 10 2017 126 624 A1 discloses a selective coating in the overhang area in the generative manufacturing of three-dimensional components, wherein inskin patterns and downskin patterns are planned together.

### SUMMARY

Embodiments of the present invention provide a method for planning local solidification of a layer of powder material with a high-energy beam while manufacturing a three-dimensional object layer by layer. The method includes, in a connected area of the layer, in which the solidification of the powder material is to take place with the high-energy beam, determining at least one inskin area and at least one downskin area, defining an inskin pattern for the at least one inskin area, and defining a downskin pattern for the at least one downskin area. The defining the inskin pattern includes defining geometric progression of a plurality of inskin vectors for the high-energy beam in the at least one inskin area. The defining the downskin pattern includes defining geometric progression of a plurality of downskin vectors for the high-energy beam in the at least one downskin area. The defining the inskin pattern within the at least one inskin area is independent of the defining the downskin pattern within the at least one downskin area. The method further includes defining a processing sequence of the plurality of inskin vectors and the plurality of downskin vectors. The defining the processing sequence includes defining a plurality of inskin vector blocks and a plurality of downskin vector blocks. Each respective inskin vector block includes one or more of the plurality of inskin vectors to be processed successively. Each respective downskin vector block includes one or more of the plurality of downskin vectors to be processed successively. The method further includes defining a vector-block sequence for processing the inskin vector blocks and the downskin vector blocks. The inskin vector blocks and the downskin vector blocks are alternately processed.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 schematically shows a longitudinal section through an exemplary 3D printer for the layer-by-layer manufacturing of a three-dimensional object, wherein a high-energy beam exposes a layer to be processed, according to some embodiments;

FIG. 2 schematically shows a plan view of a first example of a connected area of the layer to be processed, according to some embodiments;

FIG. 3 schematically shows a plan view of a second example of a connected area of the layer to be processed, according to some embodiments;

FIG. 4 schematically shows a plan view of the second example of the connected area, wherein only the inskin vectors and downskin vectors closest to a contour of the connected area are shown, according to some embodiments;

FIG. 5 schematically shows a plan view of a third example of a connected area of the layer to be processed, according to some embodiments; and

FIG. 6 schematically shows a plan view of the third example of one of the connected areas of the layer to be processed, with downskin vectors and inskin vectors running parallel and adjacent to the contour of the connected area, according to some embodiments.

### DETAILED DESCRIPTION

Embodiments of the present invention provide a method for planning the local solidification of a layer of powder material with a high-energy beam when manufacturing a three-dimensional object layer by layer, with which a high-quality, accelerated exposure of connected downskin areas and inskin areas can be carried out while avoiding overheating of these areas.

The method according to embodiments of the invention includes the following steps:
step a): in a connected area of the layer, in which solidification of the powder material is to take place with the high-energy beam, at least one inskin area and at least one downskin area are determined,
step b): an inskin pattern is defined for each inskin area, which determines the geometric progression of a plurality of inskin vectors for the high-energy beam in the inskin area, and a downskin pattern is defined for each downskin area, which defines the geometric progression of a plurality of downskin vectors for the high-energy beam in the downskin area, wherein the definition of the one or more inskin patterns within the at least one inskin area is independent of the definition of the one or more downskin patterns within the at least one downskin area;
step c): a processing sequence of all inskin vectors and downskin vectors is defined.

In step c) a plurality of inskin vector blocks and a plurality of downskin vector blocks are defined,
wherein a respective inskin vector block comprises one or more inskin vectors, which should be processed successively, and a respective downskin vector block comprises one or more downskin vectors, which should be processed successively,
and wherein a vector-block sequence for processing the inskin vector blocks and the downskin vector blocks, hereinafter collectively referred to as vector blocks, is defined, in which vector-block sequence inskin vector blocks and downskin vector blocks alternate.

The alternating processing of the inskin blocks and the downskin blocks according to embodiments of the invention reduces the risk of local overheating of the connected area of the layer while saving waiting times. The downskin area is susceptible to local overheating because heat dissipation through unsolidified powder in underlying layers is lower than through solidified powder. Embodiments of the invention can reduce the risk of overheating, particularly in the downskin area, since the material in the downskin area can cool down again after a downskin block has been processed, while the inskin block following the downskin block in the vector-block sequence is being processed. A time interval for cooling the downskin area after processing a downskin block is used at least partially for processing an inskin block within the scope of the method, whereby waiting times during which the connected area of the layer is not exposed due to the risk of overheating can be reduced or even eliminated entirely. This speeds up the exposure of the connected area without reducing the quality of the processing of the inskin areas and downskin areas.

A vector (inskin vector or downskin vector) can be a straight section of the course of the high-energy beam incident point on the layer, or can be composed as a vector train of connected partial vectors, wherein the partial vectors in particular each represent straight sections of the course of the high-energy beam incident point on the layer, typically wherein successive partial vectors have a direction differing from one another.

Typically, a vector block comprises 1 to 10 vectors, and often also just a single vector or two vectors. For a typical object, typically at least 10, usually dozens or hundreds of inskin vectors and at least 10, usually dozens or hundreds of downskin vectors are formed per layer. Typically, at least 5, and usually at least 10 inskin vector blocks and furthermore at least 5, and usually at least 10 downskin vector blocks are formed for a connected area of the layer.

The definition of the inskin patterns and the downskin patterns is independent of each other in particular in that no information about the inskin patterns (and in particular the position of individual inskin vectors) is required or applied for defining the downskin patterns (and in particular the position of individual downskin vectors), and vice versa. For the independent definition of the inskin patterns and the downskin patterns, it is substantially sufficient to know the geometry (expansion/extension) of the corresponding inskin area or downskin area. It is possible, for example, to select completely different patterns for downskin and inskin (e.g., offset filling, stripe or checkerboard pattern). The independent definition of downskin and inskin patterns does not exclude the possibility that there are parameters that apply to both (and all other) patterns, e.g., the alignment of stripes formed by the vectors or the position of the origin, from which the division into stripes of the area to be exposed begins. In particular, the inskin patterns and downskin patterns can be defined independently of one another in that adjacent inskin vectors in the inskin pattern are at least predominantly at a different distance from one another than adjacent downskin vectors in the downskin pattern and/or the inskin vectors are at least predominantly aligned obliquely to the downskin vectors.

The connected area to be exposed has a contour, wherein a contour movement of the high-energy beam can take place as part of the manufacturing method. The contour movement is defined by one or more vectors which are arranged adjacent to the contour and aligned along the contour. In particular, the exposure in the downskin area can comprise a contour movement and provide corresponding downskin vectors.

In an embodiment of the method, in step c), the vector blocks are defined such that a respective endpoint of the last vector of the earlier vector block in the layer is at least predominantly spatially spaced from a starting point of the first vector of the later vector block for each two consecutive vector blocks in the vector-block sequence.

In this embodiment, the downskin area and the inskin area are alternately exposed, wherein in the vector-block sequence there is a distance between the endpoint of the last vector of the earlier vector block in the layer and the starting point of the first vector of the later vector block, over which no irradiation by the high-energy beam takes place during the change between the vector blocks. Within the context of this application, this is referred to in particular as discontinuous exposure. By sufficiently spacing the aforementioned endpoint and the aforementioned starting point, the heat exchange between a previously exposed sub-area and a subsequently exposed sub-area of the connected area is reduced. The powder in the connected area is only heated locally in a sub-area determined by a vector block and can cool down again comparatively quickly. Locally limited heating prevents the high-energy beam from further heating a sub-area to be processed that is already heated by a heat flow from an adjacent sub-area. The risk of local overheating is further reduced and waiting times can be further reduced.

A variant of the method is advantageous in which, in step c), the vector blocks are defined such that the direction of a last vector of the earlier vector block in the layer is at least predominantly oblique to a direction of the first vector of the later vector block in two consecutive vector blocks in the vector-block sequence. This allows the alignment of the vectors to be flexibly adapted to the shape of the connected area and the shape of the downskin areas and inskin areas. In particular, the vectors can be guided along a border line of the connected area by aligning them at corners or curves. Alternatively or additionally, it is possible within the scope of the method to select a distance between adjacent downskin vectors that differs from a distance between adjacent inskin vectors. This allows the density of the downskin vectors and the inskin vectors to be adapted to the shape and expansion of the downskin area and the inskin area.

In a further embodiment of the method, the inskin vectors and the downskin vectors are defined such that the inskin vectors at least predominantly run obliquely to the downskin vectors. The course of the inskin vectors and the downskin vectors can thereby be adapted, in particular to corners or curves at the boundary between an inskin area and a downskin area.

In an advantageous variant of the method, at least for a majority of the inskin blocks for the respective inskin vector block,
the inskin vector block contains at least a first inskin vector and a last inskin vector,
and the contained inskin vectors are selected such that a starting point of the first inskin vector is located near the endpoint of the last inskin vector, in particular, wherein this starting point and this endpoint have a spacing,
which is smaller than ¼ of the length of the longest inskin vector of the inskin vector block, preferably smaller than 1/10 of the length of the longest inskin vector of the inskin vector block, and/or
which is smaller than a 25-fold hatch spacing in the inskin vector block, preferably smaller than a 10-fold hatch spacing in the inskin vector block, and/or
which is smaller than 2.5 mm, preferably smaller than 1.0 mm.

This can help reduce unproductive downtime during layer exposure. Typically, downskin blocks to be processed consecutively are located close together, and inskin blocks to be processed consecutively are also located close together, and the downskin blocks are relatively small compared to inskin blocks. By arranging the starting points/endpoints of the inskin blocks close to the downskin blocks (in a respective partial period of the exposure of the connected area), the travel paths of the high-energy beam can be minimized when changing between the vector blocks in the vector-block sequence.

In other words: Through the proximity of the starting point of the first inskin vector to the endpoint of the last inskin vector, the downskin vector block that is processed in the vector-block sequence before the respective inskin vector block and the downskin vector block that is processed in the vector-block sequence after the respective inskin vector block can be positioned close to each other. It is not necessary to reposition the high-energy beam over long distances (after a deactivation) when switching between the inskin vector block and the downskin vector blocks.

A further development of the aforementioned variant is characterized in that the starting point of the first inskin vector is adjacent to a boundary between the associated inskin area of the inskin vector block and an adjacent downskin area, and in that the first inskin vector leads away, from the starting point, from the adjacent downskin area, and the last inskin vector leads back to the adjacent downskin area. As a result, after processing a downskin block of the adjacent downskin area, the high-energy beam is positioned comparatively close to the starting point of the first inskin vector of the inskin vector block of the inskin area and can be quickly guided to this starting point. After processing the inskin vector block associated with the first inskin vector, the high-energy beam is again positioned close to the adjacent downskin area and can be quickly guided to the next downskin vector block in the adjacent downskin area in the vector-block sequence of processing.

A variant of the method is preferable in which, at least in a majority of inskin blocks, a respective inskin block is formed by an even number of, in particular two, four or six, adjoining inskin vectors, which have an alternating opposite direction, in particular wherein the inskin vectors run parallel to one another. The parallel alignment of the vectors is advantageously used for hatching to create a structurally simple hatched pattern, which serves to guide the high-energy beam during exposure of the connected area. Due to the even number of vectors, the starting point of the first vector and the endpoint of the last vector can be close together, in particular if the adjacent inskin vectors are approximately the same length.

In a further variant, at least for some of the downskin vectors, the course of the respective downskin vector follows the course of an adjacent contour, in particular an outer contour, of the associated downskin area. This enables the downskin area to be processed in a simple manner by the high-energy beam along a contour of the downskin area, preferably traversing the contour in the form of contour movements, in particular along curves or corners of the contour in the downskin area. In particular, the downskin area can be increased outwardly on a manufactured section of the inskin area, which is advantageous for rapid heat dissipation and the prevention of overheating. In particular, a plurality of downskin vectors can be provided for a contour section at different distances from the contour, which downskin vectors follow the course of the contour.

A variant of the method is advantageous, which is characterized in that in step c), the inskin vector blocks and the downskin vector blocks are defined in such a way that, on a respective boundary section between an inskin area and a downskin area, firstly, all inskin vectors, which are at least partially located on or near this boundary section, are processed, and then all downskin vectors, which are at least partially located on or near this boundary section, are processed. By processing an inskin area before an adjacent downskin area, heat flow from the connected area is improved because heat can at least partially flow from the downskin area to the inskin area. From there, the heat flows away better than directly from the downskin area, under which there is unsolidified (unmelted) powder. This embodiment of the method enables a more rapid cooling of an area processed with the high-energy beam (in particular the downskin area) in the connected area.

In particular, a vector is considered to be close to a boundary section if, during the manufacturing of the vector, a noticeable heat conduction through the boundary section takes place. The length of the boundary section can, for example, correspond to the length of adjacent downskin vectors.

A further development of the aforementioned variant is characterized in that downskin vectors positioned at least partially closer to the boundary section are processed before downskin vectors positioned further from the boundary section. As a result, during the processing of the downskin vectors, a connection based on solidified powder of the subsections of the downskin area to be exposed, determined by the downskin vectors, to an inskin area by the boundary is guaranteed. This results in improved heat flow from the downskin area through the inskin area during processing of the downskin area to cool the downskin area more quickly.

In a preferred variant, in the context of step c), waiting times are further defined at least between some consecutive vector blocks of the vector-block sequence, during which the processing with the high-energy beam is to be paused. During the waiting times, the connected area cools down between processing sequences with the high-energy beam to reduce the risk of overheating. Alternatively or additionally, waiting times can also be provided within the vector blocks.

A further variant of the method is characterized in that at least some inskin vector blocks that follow one another in the vector-block sequence, alternating with downskin vector blocks, are arranged adjacent to one another in the associated inskin area, and/or
at least some downskin vector blocks that follow one another in the vector-block sequence, alternating with inskin vector blocks, are arranged adjacent to one another in the associated downskin area.

By successively processing adjacent vector blocks in the vector-block sequence, connected areas of the connected area are processed, thereby increasing the stability of the connected area during the processing process. In particular, the formation of island-shaped exposed areas surrounded by unexposed areas is avoided. Such island-shaped exposed areas can relatively easily change their position or alignment in an undesirable manner (for example due to the different density and/or strength of the exposed areas in relation to areas not yet exposed).

Embodiments of the invention also include a computer program product which, when executed on a control device of a 3D printer or a planning device, carries out a method according to embodiments of the invention described above. Such a computer program product can be distributed separately from 3D printers or planning devices with little effort, wherein after installation of the computer program product on a suitable control device of a 3D printer or a planning device, a planning method according to embodiments of the invention can be carried out.

Embodiments of the invention also include a control device of a 3D printer or a planning device which is programmed to carry out a method according to embodiments of the invention described above. The control device serves to control a 3D printer and, among other things, carries out the planning method according to embodiments of the invention, in particular according to the instructions of an aforementioned computer program product. Alternatively, a planning device independent of a 3D printer (usually set up on a PC or server) can be used to carry out the method according to embodiments of the invention according to the program; the result of the planning method is then passed on to an independent 3D printer to carry out the build process.

Embodiments of the invention also include a method for the layer-by-layer manufacturing of a three-dimensional object, in which a powder material is locally solidified in successive layers using a high-energy beam,
wherein, for at least some of the layers, in each case
   (step alpha) a planning of the local solidification in the layer is carried out according to a method as described above according to embodiments of the invention, and
   (step beta) the local solidification of the layer is carried out according to the planning of step alpha, by using the high-energy beam to process the inskin vectors and downskin vectors defined in step b) in the order defined in step c) of the planning for this layer.

By planning the exposure of the inskin areas and downskin areas in a connected area according to embodiments of the invention, a high-quality, accelerated exposure of these areas can be carried out as part of the manufacturing method.

Embodiments of the invention also include a 3D printer with a control device, wherein the control device is programmed to carry out the aforementioned manufacturing method according to embodiments of the invention on the 3D printer. Such a 3D printer is designed to plan and carry out the exposure of the downskin areas and inskin areas in the connected area according to embodiments of the invention in order to process these areas with high quality and speed and in particular without local overheating.

Exemplary embodiments of the invention are described below with reference to the drawings. Similarly, the features mentioned above and those still to be further presented can be used in each case individually or together in any desired combinations. The embodiments shown and described should not be understood as an exhaustive list.

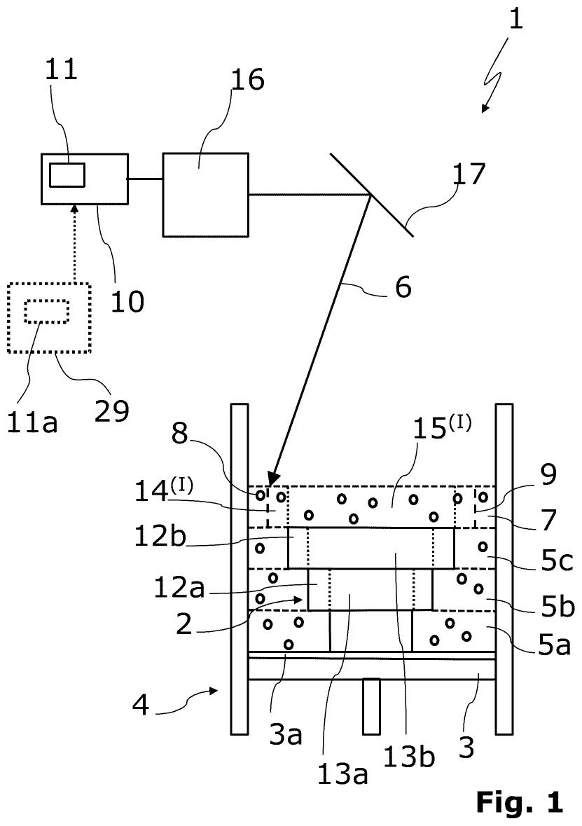

FIG. 1 schematically shows a longitudinal section through an exemplary 3D printer 1 for the layer-by-layer manufacturing of a three-dimensional object 2. The object 2 is raised on a substrate 3a, which is arranged on a lifting table 3 in a manufacturing chamber 4 of the 3D printer 1, wherein the lifting table 3 enables a vertical movement of the substrate 3a and the object 2. The object 2 is manufactured from powder layers 5a, 5b, 5c in the manufacturing chamber. To manufacture the object, the powder from the powder layers 5a, 5b, 5c is successively solidified locally in the powder layers 5a, 5b, 5c using a high-energy beam 6 from the 3D printer 1. At the time shown in FIG. 1, a(n) (uppermost) layer 7 of powder 8 to be processed is irradiated with the high-energy beam 6 in order to cause local solidification of the layer 7 to be processed. Unsolidified powder 8 is marked here by rings. Accordingly, the object 2 is formed layer by layer. The high-energy beam 6 is generated in a beam source 16 and aligned through a mirror 17. The planned boundary 9 of the object 2 in the layer 7 to be processed is indicated in FIG. 1 by dashed boundary lines. The manufacturing process is controlled by a control device 10 of the 3D printer 1. The control device 10 is designed here, with the help of a computer program product 11 or its program, to plan the local solidification for the layer 7 to be processed, before this local solidification is carried out. In addition, the control device 10 also carries out the solidification of the respective layer to be processed.

Alternatively, it is also possible to provide a separate planning device 29, on which the local solidification of the layer 7 (shown by dotted lines) to be processed is planned with the help of a computer program product 11a or its program; the planning device 29 then forwards the received planning to the control equipment 10, which then controls the actual solidification of the layer 7.

When planning the local solidification, a distinction must be made between downskin areas and inskin areas of the object 2, wherein the reference symbols 12a, 12b indicate examples of downskin areas of the layers 5b, 5c and the reference symbols 13a, 13b indicate examples of inskin areas of the layers 5b, 5c that must be taken into account when manufacturing the object 2 in the layers 5b, 5c. The reference symbol 14^{(I)} indicates an exemplary downskin area of the layer 7 to be processed, while the reference symbol 15^{(I)} indicates an inskin area of the layer 7 to be processed. The inskin areas 13a, 13b, 15^{(I)} usually require different treatment than the downskin areas 12a, 12b, 14^{(I)} during the local solidification of the respective layer with the high-energy beam 6, for example with regard to the position, orientation and density of the vectors and/or the beam parameters, in particular to avoid the risk of local overheating.

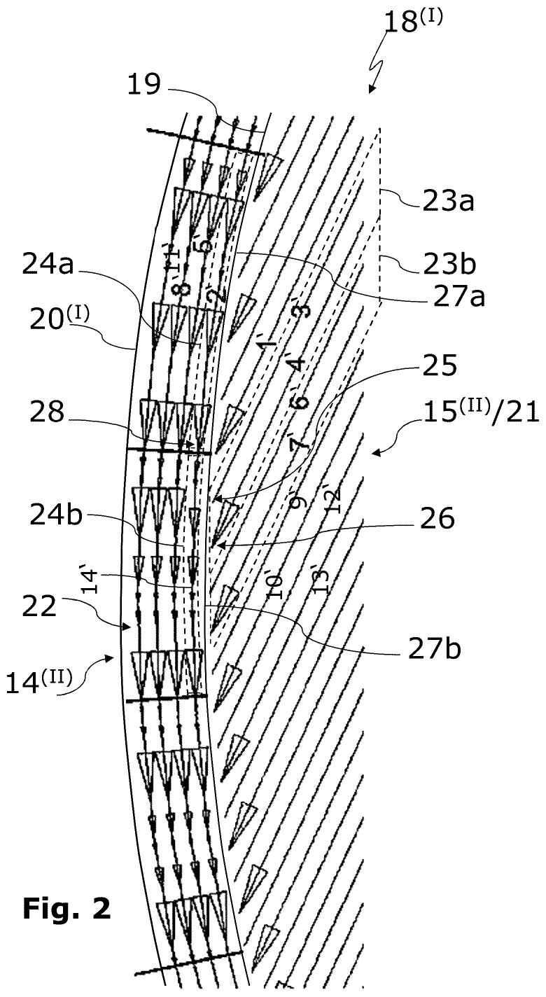

FIG. 2 schematically shows a plan view of a first example of a connected area 18^{(I)} of the layer 7 to be processed (see FIG. 1), wherein in the connected area 18^{(I)} exposure of the layer 7 to be processed should take place with the high-energy beam. The connected area 18^{(I)} is made up (as shown in FIG. 2) of an inskin area 15^{(II)} and a downskin area 14^{(II)}. The downskin area 14^{(II)} is separated from the inskin area 15^{(II)} through a boundary 19 with boundary sections, wherein in FIG. 2 a boundary section 27a is shown as an example, which extends approximately over the longitudinal area of the downskin vector 2′, and a boundary section 27b, which extends approximately over the longitudinal area of the downskin vector 14′. The downskin area 14^{(II)} is limited outwardly by a contour 20^{(I)}.

When planning the solidification of the connected area 18^{(I)}, inskin vectors are defined for the inskin area 15^{(II)}, wherein, in FIG. 2, the inskin vectors 1′, 3′, 4′, 6′, 7′, 9′, 10′, 12′, 13′ are marked by way of example. The movement of the high-energy beam 6 during the exposure process in the inskin area 15^{(II)} is determined by the inskin vectors 1′, 3′, 4′, 6′, 7′, 9′, 10′, 12′, 13′. Accordingly, for the downskin area 14^{(II)}, downskin vectors are defined, of which the downskin vectors 2′, 5′, 8′, 11′, 14′ are marked by way of example in FIG. 2. The downskin vectors 2′, 5′, 8′, 11′, 14′ serve to determine the movement of the high-energy beam 6 during the exposure method in the downskin area 14^{(II)}. It can be seen here that the downskin vectors 2′, 5′, 8′, 11′, 14′ each start and end at radially outward-directed marking lines in FIG. 2.

An inskin pattern 21 is thus determined for the inskin area 15^{(II)}, which comprises the inskin vectors 1′, 3′, 4′, 6′, 7′, 9′, 10′, 12′, 13′ and in particular defines the positions, lengths and/or alignments of the vectors. Correspondingly, for the downskin area 14^{(II)}, a downskin pattern 22 is determined, which comprises the downskin vectors 2′, 5′, 8′, 11′, 14′ and in particular defines the positions, lengths and/or alignments. The inskin pattern 21 and the downskin pattern 22 are selected independently of one another during planning. This can be seen here in particular from the fact that the inskin vectors 1′, 3′, 4′, 6′, 7′, 9′, 10′, 12′, 13′ run obliquely to the downskin vectors 2′, 5′, 8′, 11′, 14′.

FIG. 2 illustrates an exposure method of the connected area 18^{(I)} from a point in time, at which the inskin vectors (not numbered) above the inskin vector marked 1′ have already been processed. In the processing sequence of vectors 1′-13′, which was defined within the framework of the planning according to embodiments of the invention, the vectors 1′-13′ are processed in ascending order according to their number.

In the processing sequence, several inskin vector blocks and downskin vector blocks are introduced, wherein in FIG. 2 the inskin vector blocks 23a, 23b and the downskin vector blocks 24a, 24b are shown by way of example (see dashed frames). The inskin vector blocks 23a and 23b each comprise two inskin vectors, in FIG. 2 by way of example 3′, 4′ and 6′, 7′, whereas the downskin vector blocks 24a and 24b each comprise one downskin vector, 2′ and 14′ in FIG. 2 by way of example. The inskin vectors 1′, 3′, 4′, 6′, 7′, 9′, 10′, 12′, 13′ and downskin vectors 2′, 5′, 8′, 11′, 14′ are successively processed in their respective vector blocks 23a, 23b and 24a, 24b as part of the solidification of the connected area 18^{(I)}.

In the processing sequence, initially the inskin vector 1′ is now processed for alternating exposure of the inskin area 15^{(II)} and the downskin area 14^{(II)}. Subsequently, the downskin vector 2′ is processed in the downskin vector block 24a. Thereafter, the inskin vectors 3′ and 4′ are processed in the inskin vector block 23a, wherein the high-energy beam 6 on the inskin vector 3′ is removed from the downskin area 14^{(II)} and then introduced to the downskin area 14 on the inskin vector 4′^{(II)} again. Then the downskin vector 5′ is processed. The inskin vectors 6′ and 7′ are subsequently processed in the inskin vector block 23b. This is followed by the downskin vector 8′. The inskin vectors 9′ and 10′ are then processed. The downskin vector 11′, which is closest to the contour 20^{(I)}, is then processed. The inskin vectors 12′ and 13′ are then processed. This is followed by the processing of the downskin vector 14′ in the downskin vector block 24b.

The downskin vectors 2′, 5′, 8′, 11′ are manufactured consecutively (alternating with inskin vector blocks, including 23a and 23b), so that material is melted onto the boundary section 27a from the inside outwards.

Because the inskin vectors 1′, 3′, 4′, 6′, 7′, 9′ and 10′ have been processed before the downskin vector 14′ is started, material can be melted onto the boundary section 27b using the downskin vector 14′, wherein the boundary section 27b has already been solidified.

In order to be able to minimize the travel paths of the high-energy beam 6 (see FIG. 1), the inskin vectors 1′, 3′, 4′, 6′, 7′, 9′, 10′, 12′, 13′ are selected here in such a way that in an inskin vector block, for example in the inskin vector block 23a, a starting point 25 of a first inskin vector (in the sequence of processing), here 3′ as an example, near an endpoint 26 of a last inskin vector, here 4′ as an example, is located in the relevant inskin vector block 23a. Furthermore, the starting point 25 of the first inskin vector 3′ here is adjacent to the boundary 19 between the associated inskin area 15^{(II)} of the inskin vector block 23a and the downskin area 14^{(II)}, in order to enable a rapid change of the high-energy beam 6 (see FIG. 1) from the downskin area 14^{(II)} to the inskin vector block 23a. Here, the first inskin vector 3′ leads away, from the starting point 25, from the adjacent downskin area 14^{(II)}, whereas the last inskin vector 4′ leads back to the adjacent downskin area 14^{(II)}, whereby the high-energy beam 6 can quickly be returned to the downskin area 14^{(II)} after processing the inskin vector block 23a. The first and the last inskin vector 3′, 4′ are antiparallel to an effective guidance of the high-energy beam 6, i.e., they have an alternating opposite direction.

In order to only heat the connected area 18^{(I)} locally during exposure, the vector blocks 23a, 23b, 24a, 24b are preferably defined such that in each case two consecutive vector blocks 24a, 23b in the vector-block sequence, a respective endpoint, here an endpoint 28 of the last vector 2′ of the former vector block 24a by way of example, is spatially spaced from a starting point of the later vector block, here the starting point 25 of the first vector 3′ of the later vector block 23b by way of example.

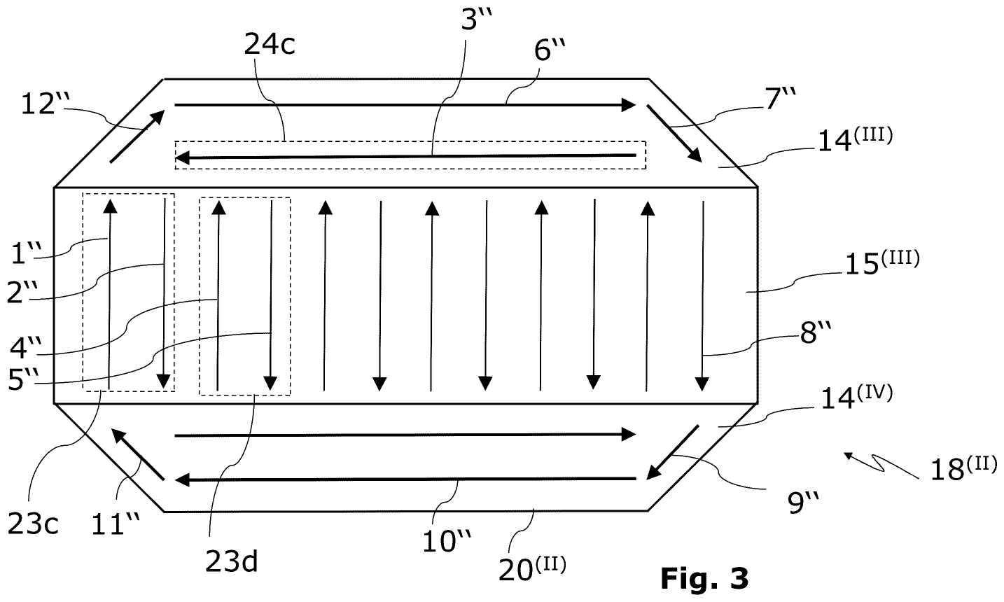

FIG. 3 schematically shows a plan view of a second example of the connected area 18^{(II)} of the layer 7 to be processed (see FIG. 1). The connected area 18^{(I)} shown in FIG. 3 is composed of an inskin area 15^{(III)} and a first downskin area 14^{(III)} and a second downskin area 14^{(IV)}, which border the inskin area 15^{(III)}, wherein the inskin area 15^{(III)} is positioned here between the two downskin areas 14^{(III)}, 14^{(IV)}.

To guide the high-energy beam 6 (see FIG. 1), inskin vectors are again defined in the inskin area 15^{(III)}, some of which are labeled 1″, 2″, 4″, 5″, 8″ by way of example, and in the downskin areas, downskin vectors are defined, some of which are labeled 3″, 6″, 7″, 12″ and 9″, 10″, 11″ by way of example. In this second example, some of the downskin vectors (for example, the downskin vectors 3″, 6″) run antiparallel to each other in order to enable effective guidance of the high-energy beam 6 (see FIG. 1). The downskin vectors 3″, 6″, 7″, 12″ and 9″, 10″, 11″ are aligned obliquely or perpendicular to the inskin vectors 1″, 2″, 4″, 5″, 8″, whereby the downskin vectors 3″, 6″, 7″, 12″ and 9″, 10″, 11″ are selected in particular independently of the inskin vectors 1″, 2″, 4″, 5″, 8″.

The inskin vectors are combined to form inskin vector blocks, wherein inskin vector blocks 23c and 23d are shown by way of example for the inskin vectors 1″, 2″, and 4″, 5″. Accordingly, the downskin vectors are combined to form downskin vector blocks, of which a downskin vector block 24c is shown by way of example for the downskin vector 3″. The inskin vector blocks and the downskin vector blocks are processed alternately in a vector-block sequence (not illustrated in detail, in particular the numbering of the vectors here only partially corresponds to the processing sequence). The downskin areas 14^{(III)}, 14^{(IV)} and the inskin area 15^{(III)} are bordered together by a contour 20^{(II)}.

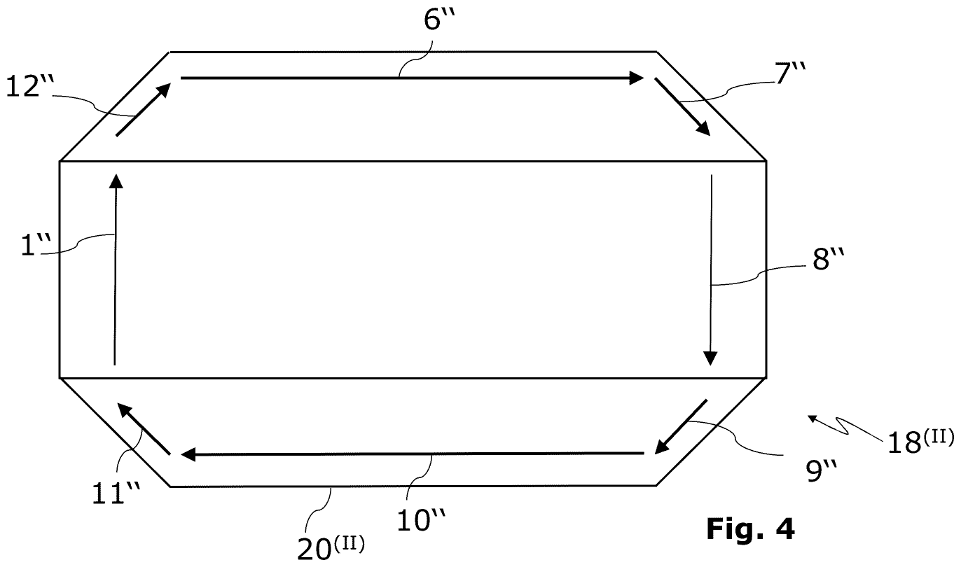

FIG. 4 schematically shows a plan view of the second embodiment of the connected area 18^{(II)}, wherein only the inskin vectors 1″, 8″ and downskin vectors 6″, 7″, 9″, 10″, 11″ 12″, closest to the contour 20^{(II)} are shown. These inskin vectors 1″, 8″ and downskin vectors 6″, 7″, 9″, 10″, 11″, 12″ can be used to melt the contour 20^{(II)} of the connected area 18^{(II)} in a contour movement defined by these vectors, if necessary again after these vectors have already been processed during the exposure of the connected area 18^{(II)}.

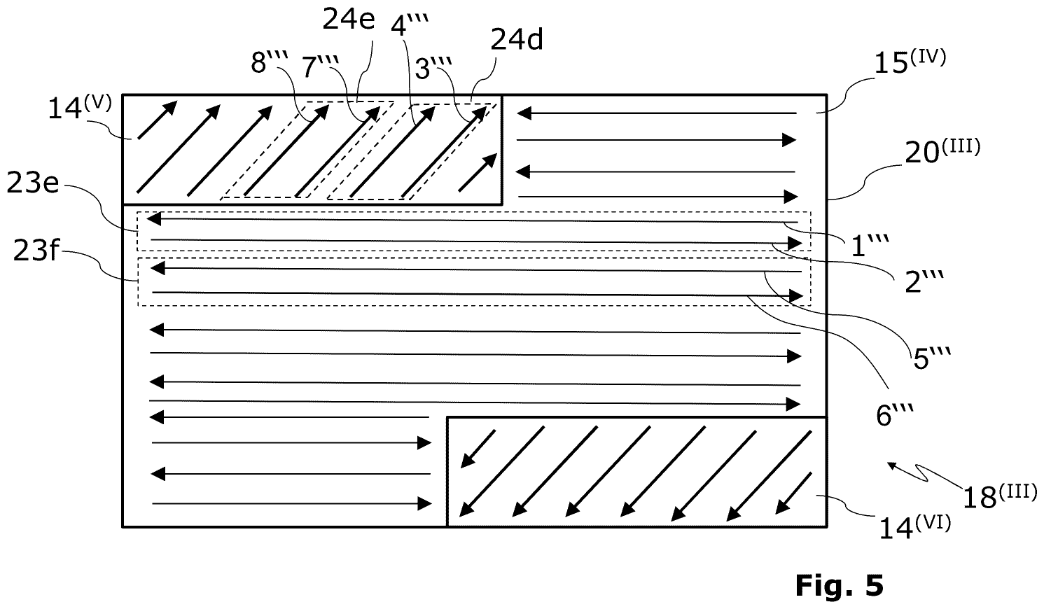

FIG. 5 schematically shows a plan view of a third example of a connected area 18^{(III)} of the layer 7 to be processed. The rectangular connected area 18^{(III)} shown in FIG. 5 is composed of an inskin area 15^{(IV)} and a first downskin area 14^{(V)} and a second downskin area 14^{(VI)}, wherein the downskin areas 14^{(V)}, 14^{(VI)} are formed here at opposite corners of the connected area 18^{(III)}.

The downskin vectors, some of which are labeled 3′″, 4′″, 7″′ and 8′″ in FIG. 5, are aligned parallel to one another and obliquely to a contour 20^{(III)} of the connected area 18^{(III)} in the respective downskin areas 14^{(V)}, 14^{(VI)}, wherein two downskin vectors, for example the downskin vectors 3′″, 4′″ or 7′″, 8′″, are combined to form a downskin vector block, here the downskin vector blocks 24d and 24e by way of example. The downskin vectors 3′″, 4′″, 7′″ and 8″′ point towards the contour 20^{(III)} of the connected area 18^{(III)}, such that the high-energy beam 6 (see FIG. 1) is guided, during the exposure of the relevant downskin area 14^{(V)}, 14^{(VI)}, from the interior of the connected area 18^{(III)} to the contour 20^{(III)}, in order to improve the mechanical stability and facilitate a better heat outflow during the exposure of the downskin vectors 3′″, 4′″, 7″′ and 8″′. The inskin vectors, some of which are labeled 1′″, 2′″, 5′″ and 6′″ in FIG. 5 by way of example, are aligned antiparallel in the respective inskin vector blocks 23e, 23f, which allows efficient guidance of the high-energy beam 6 (see FIG. 1).

In the processing sequence, for example, the inskin vectors 1′″ and 2′″ are first processed in the inskin vector block 23e for alternating exposure of the inskin area 15^{(IV)} and the downskin area 14^{(V)}. Subsequently, the downskin vectors 3″, 4″ are processed in the downskin vector block 24d. This is followed by the processing of the inskin vectors 5″, 6″ in the inskin vector block 23f. Thereafter, the downskin vectors 7″′, 8″′ are processed in the downskin vector block 24e.

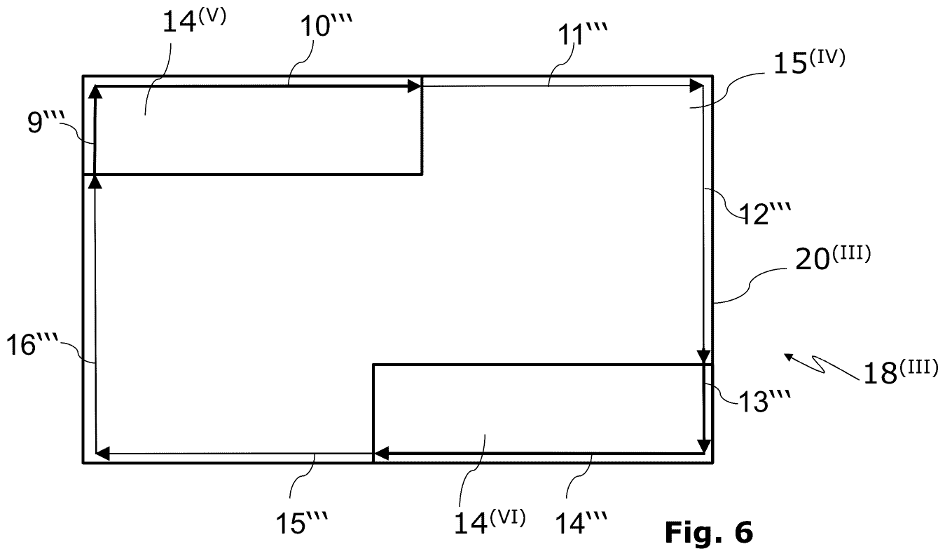

FIG. 6 schematically shows a plan view of a third example of the connected area 18^{(III)}, wherein, in the inskin area 15^{(IV)} or the downskin areas 14^{(V)}, 14^{(VI)}, downskin vectors 9′″, 10′″ and 13″′, 14′″ and inskin vectors 11′″, 12″′ and 15′″, 16′″ run parallel and adjacent to the contour 20^{(III)} of the connected area 18^{(III)}. These vectors are provided in addition to the vectors shown in FIG. 5 in the connected area 18^{(III)}. The high-energy beam 6 can be guided along the downskin vectors 9′″, 10′″ and 13′″, 14″′ and inskin vectors 11′″, 12′″ and 15′″, 16′″ shown in FIG. 6 in order to carry out a contour movement and to melt the contour 20^{(III)} of the connected area 18^{(III)}. This contour movement typically takes place finally, after processing the vectors shown schematically in FIG. 5. The vectors 9′″ to 16′″ are processed in ascending order of their number.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SYMBOLS

1 3D printer
2 Three-dimensional object
3 Lifting table
3a Substrate
4 Manufacturing chamber
5a-5c Powder layers
6 High-energy beam
7 Layer to be processed
8 Powder
9 Planned delimitation in the layer to be processed
10 Control device
11 Computer program product
11a Computer program product
12a-12b Downskin areas of the layers 5b, 5c
13a-13b Inskin areas of the layers 5b, 5c
14^{(I)-(VI)} Downskin area of the layer to be processed
15^{(I)-(IV)} Inskin area of the layer to be processed
16 Beam source
17 Mirror
18^{(I)-(III)} Connected area
19 Boundary
20^{(I)-(III)} Contour
21 Inskin pattern
22 Downskin pattern
23a-23f Inskin vector blocks
24a-24e Downskin vector blocks
25 Starting point of a first inskin vector
26 Endpoint of a last inskin vector
27a, 27b Boundary sections
28 Endpoint of the last vector of the earlier vector block
29 Planning device
1′ Inskin vector
2′ Downskin vector
3′-4′ Inskin vector
5′ Downskin vector
6′-7′ Inskin vector
8′ Downskin vector
9′-10′ Inskin vector
11′ Downskin vector
12′-13′ Inskin vector
14′ Downskin vector
1″-2″ Inskin vector
3″ Downskin vector
4″-5″ Inskin vector
6″ Downskin vector
7″ Downskin vector
8″ Inskin vector
9″-12″ Downskin vector
1′″-2′″ Inskin vector
3′″-4″′ Downskin vector
5′″-6′″ Inskin vector
7″′-10′″ Downskin vector
11′″-12′″ Inskin vector
13′″-14′″ Downskin vector
15′″-16′″ Inskin vector

1. A method for planning local solidification of a layer of powder material with a high-energy beam while manufacturing a three-dimensional object layer by layer, the method comprising:
in a connected area of the layer, in which the solidification of the powder material is to take place with the high-energy beam, determining at least one inskin area and at least one downskin area,
defining an inskin pattern for the at least one inskin area, wherein the defining the inskin pattern comprises defining geometric progression of a plurality of inskin vectors for the high-energy beam in the at least one inskin area, and defining a downskin pattern for the at least one downskin area, wherein the defining the downskin pattern comprises defining geometric progression of a plurality of downskin vectors for the high-energy beam in the at least one downskin area, wherein the defining the inskin pattern within the at least one inskin area is independent of the defining the downskin pattern within the at least one downskin area;
defining a processing sequence of the plurality of inskin vectors and the plurality of downskin vectors, wherein the defining the processing sequence comprises defining a plurality of inskin vector blocks and a plurality of downskin vector blocks, wherein each respective inskin vector block comprises one or more of the plurality of inskin vectors to be processed successively, and each respective downskin vector block comprises one or more of the plurality of downskin vectors to be processed successively, and
defining a vector-block sequence for processing the inskin vector blocks and the downskin vector blocks, wherein the inskin vector blocks and the downskin vector blocks are alternately processed.

2. The method according to claim 1, wherein the inskin vector blocks and the downskin vector blocks are defined such that a respective endpoint of a last vector of an earlier vector block in the layer is at least predominantly spatially spaced from a starting point of a first vector of a later vector block for each two consecutive vector blocks in the vector-block sequence.

3. The method according to claim 1, wherein the inskin vector blocks and the downskin vector blocks are defined such that a direction of a last vector of an earlier vector block in the layer is at least predominantly oblique to a direction of a first vector of a later vector block in two consecutive vector blocks in the vector-block sequence.

4. The method according to claim 1, wherein the inskin vectors and the downskin vectors are defined such that the inskin vectors at least predominantly run obliquely to the downskin vectors.

5. The method according to claim 1, wherein, at least for a majority of the inskin vector blocks,
a respective inskin vector block contains at least a first inskin vector and a last inskin vector, and inskin vectors contained therein are selected so that a starting point of the first inskin vector is located near an endpoint of the last inskin vector.

6. The method according to claim 5, wherein the starting point and the endpoint have a spacing therebetween.

7. The method according to claim 6, wherein the spacing is smaller than ¼ of a length of a longest inskin vector of the respective inskin vector block.

8. The method according to claim 6, wherein the spacing is smaller than a 25-fold hatch spacing in the respective inskin vector block.

9. The method according to claim 6, wherein the spacing is smaller 2.5 mm.

10. The method according to claim 5, wherein the starting point of the first inskin vector is adjacent to a boundary between an associated inskin area-of the inskin vector block and an adjacent downskin area, and the first inskin vector leads away from the starting point, from the adjacent downskin area, and the last inskin vector leads back to the adjacent downskin area.

11. The method according to claim 1, wherein, at least in a majority of the inskin vector blocks, a respective inskin vector block is formed by an even number of adjoining inskin vectors, which have an alternating opposite direction.

12. The method according to claim 1, wherein, at least for some of the downskin vectors, a course of a respective downskin vector follows a course of an adjacent outer contour of an associated downskin area.

13. The method according to claim 1, wherein, the inskin vector blocks and the downskin vector blocks are defined in such a way that, on a respective boundary section between an inskin area and a downskin area, firstly, all inskin vectors that are at least partially located on or near the respective boundary section are processed, and then all downskin vectors that are at least partially located on or near the respective boundary section are processed.

14. The method according to claim 9, wherein downskin vectors positioned at least partially closer to the respective boundary section are processed before downskin vectors positioned further from the respective boundary section.

15. The method according to claim 1, further comprising defining waiting times at least between some consecutive vector blocks of the inskin vector blocks and/or the downskin vector blocks of the vector-block sequence, wherein during the waiting times, processing with the high-energy beam is to be paused.

16. The method according to claim 1, wherein at least some inskin vector blocks that follow one another in the vector-block sequence, alternating with downskin vector blocks, are arranged adjacent to one another in an associated inskin area, and/or
at least some downskin vector blocks that follow one another in the vector-block sequence, alternating with inskin vector blocks, are arranged adjacent to one another in an associated downskin area.

17. A non-transitory computer-readable medium having a computer program stored thereon, the computer program, when executed by a control device of a 3D printer or a planning device, causing performance of a method according to claim 1.

18. A control device of a 3D printer or planning device, programmed to carry out a method according to claim 1.

19. A method for layer-by-layer manufacturing of a three-dimensional object, wherein a local solidification of a powder material is carried out in layers with a high-energy beam, wherein, for at least some of the layers, a planning of the local solidification in each respective layer is carried out according to claim 1 and the local solidification of the respective layer is carried out according to the planning, by using the high-energy beam to define the inskin vectors and the downskin vectors.

20. A 3D printer with a control device, wherein the control device is programmed to carry out a method according to claim 19 on the 3D printer.
